(19) United States
(12) Patent Application Publication
(10) Pub. No.: US 2023/0007237 A1
(43) Pub. Date: Jan. 5, 2023

(54) FILTER GENERATION METHOD, FILTER GENERATION APPARATUS AND PROGRAM

(71) Applicant: NIPPON TELEGRAPH AND TELEPHONE CORPORATION, Tokyo (JP)

(72) Inventors: Takehito MIYAZAWA, Tokyo (JP); Yukihiro BANDO, Tokyo (JP); Takayuki KUROZUMI, Tokyo (JP); Hideaki KIMATA, Tokyo (JP)

(73) Assignee: NIPPON TELEGRAPH AND TELEPHONE CORPORATION, Tokyo (JP)

(21) Appl. No.: 17/782,109

(22) PCT Filed: Dec. 5, 2019
(86) PCT No.: PCT/JP2019/047655

§ 371 Date: Jun. 2, 2022

(51) Int. Cl. H04N 19/105; H04N 19/60; H04N 19/159; H04N 19/176

(52) U.S. Cl. CPC H04N 19/105; H04N 19/60; H04N 19/159; H04N 19/176

(57) ABSTRACT

A filter generation method according to one embodiment is a filter generation method for generating a filter for an inter prediction image in moving image coding or video coding, wherein a computer executes a first acquisition procedure for acquiring, for each of subblocks included in a coding object block, a region in a reference image that corresponds to the subblock, a second acquisition procedure for referring to block segmentation information of the reference image and acquiring a coding block that is a block of the reference image which includes the region, and a generation procedure for generating, for the coding object block or each of a plurality of coding object blocks, an image obtained by performing an inverse transformation on one or more coding blocks each acquired in the second acquisition procedure as the filter.

### TECHNICAL FIELD

The present invention relates to a filter generation method, a filter generation device, and a program.

### BACKGROUND ART

As one of moving image coding techniques or video coding techniques, inter coding is known. Inter coding approximates a coding object image by rectangles through block segmentation, searches for a motion parameter between the coding object image and a reference image on a block-by-block basis, and generates a prediction image (e.g., Non-Patent Literature 1). Here, as for the motion parameter, translation represented by two parameters, a movement distance in a longitudinal direction and a movement distance in a lateral direction, has been used.

It is known that, if there is a distortion of a subject (an object) which cannot be fully represented by translation, additional utilization of a higher-order motion, such as affine transformation or projective transformation, increases prediction accuracy and improves coding efficiency. For example, Non-Patent Literature 2 makes a prediction using affine transformation on a distortion of a subject associated with movement of a camera. For example, Non-Patent Literature 3 applies affine transformation, projective transformation, and bilinear transformation on inter-view prediction in a multi-view image.

If a pixel located at coordinates (x, y) is subjected to affine transformation, coordinates (x′, y′) after the pixel transformation are given by the following expression (1):

$$\begin{matrix}[ Math . 1 ] & \\ \{ \begin{matrix}{x}^{′} = ax + b y + c \\ {y}^{′} = dx + e y + f\end{matrix} & ( 1 )\end{matrix}$$

where a, b, c, d, and e are affine parameters.

As a next-generation standard under review by JVET (Joint Video Experts Team), VVC (Versatile Video Coding) is known (Non-Patent Literature 4). VVC adopts 4/6-parameter affine prediction mode. In 4/6-parameter affine prediction mode, a coding block is segmented into 4×4 subblocks, and per-pixel affine transformation is approximated by per-subblock translation. At this time, in 4-parameter affine prediction mode, a motion vector of each subblock is calculated using four parameters (mv₀ₓ, mv_{0y}, mv₁ₓ, and mv_{1y}) composed of two vectors, motion vectors v₀ (=(mv₀ₓ, mv_{0y})) and v₁ (=(mv₁ₓ, mv_{1y})) of control points located in the upper left and the upper right of the subblock, as shown in FIG. 1, by the following expression (2):

$$\begin{matrix}[ Math . 2 ] & \\ \{ \begin{matrix}{mv}_{x} = \frac{m {v}_{1 x} - m {v}_{0 x}}{W} x + \frac{m {v}_{1 y} - m {v}_{0 y}}{W} y + m {v}_{0 x} \\ {mv}_{y} = \frac{m {v}_{1 y} - m {ν}_{0 y}}{W} x + \frac{m {v}_{1 x} - m {v}_{0 x}}{W} y + m {v}_{0 y}\end{matrix} & ( 2 )\end{matrix}$$

where W is a lateral pixel size of the coding block, and H is a longitudinal pixel size of the coding block.

In contrast, in 6-parameter affine prediction mode, the motion vector is calculated using six parameters (mv₀ₓ, mv_{0y}, mv₁ₓ, mv_{1y}, mv₂ₓ, and mv_{2y}) composed of three vectors obtained by adding a motion vector v₂ (=(mv₂ₓ, mv_{2y})) of a control point located in the lower left of the subblock, as shown in FIG. 1, by the following expression (3):

$$\begin{matrix}[ Math . 3 ] & \\ \{ \begin{matrix}{mv}_{x} = \frac{m {v}_{1 x} - m {v}_{0 x}}{W} x + \frac{m {v}_{2 x} - m {v}_{0 x}}{H} y + m {v}_{0 x} \\ {mv}_{y} = \frac{m {v}_{1 y} - m {ν}_{0 y}}{W} x + \frac{m {v}_{2 y} - m {v}_{0 y}}{H} y + m {v}_{0 y}\end{matrix} & ( 3 )\end{matrix}$$

As described above, VVC reduces the amount of computation by approximating affine transformation by a combination of translations.

Note that merge mode is adopted in VVC, as in H.265/HEVC. Merge mode is also applied to a coding block to which affine prediction mode is applied. In merge mode, a merge index indicating a position of an adjacent coded block is transmitted instead of transmitting a motion parameter of a coding object block, and decoding is performed using a motion vector of the coded block at the position indicated by the index.

### CITATION LIST

### Non-Patent Literature

Non-Patent Literature 1: Recommendation ITU-T H.265: High efficiency video coding, 2013
Non-Patent Literature 2: H. Jozawa et al. “Two-stage motion compensation using adaptive global MC and local affine MC.” IEEE Trans. on CSVT 7.1 (1997): 75-85.
Non-Patent Literature 3: R-J-S. Monteiro et al. “Light field image coding using high-order intrablock prediction.” IEEE Journal of Selected Topics in Signal Processing 11.7 (2017): 1120-1131.
Non-Patent Literature 4: JVET-M1002-v1_encoder description VTM4

### SUMMARY OF THE INVENTION

### Technical Problem

However, affine transformation, projective transformation, or the like needs more parameters than those in the case of translation. The amount of computation needed for estimation and coding overhead increase, which leads to inefficiency.

Although VVC can reduce the amount of computation, per-subblock translation cannot completely capture deformation of an object. This may cause protrusion of a reference range, a failure to pick up a pixel, or the like, leading to an increase in prediction error. For example, if an object in a reference image undergoes shear deformation, rotational deformation, scaling deformation, or the like, as shown in FIG. 2, protrusion of a reference range or a failure to pick up a pixel occurs. Especially if, an object in a coding object image has deformed from a rectangle, as shown in FIG. 3, errors accumulate at both the coding object image and a reference image to further increase a prediction error. That is, a scheme which makes a prediction by per-subblock translation cannot fully represent affine transformation, especially if an object in a coding object image is hard to approximate by rectangles.

An object of an embodiment of the present invention, which has been made in view of the above-described points, is to reduce a prediction error while curbing the amount of computation.

### Means for Solving the Problem

In order to attain the above-described object, a filter generation method according to the one embodiment of the present invention is a filter generation method for generating a filter for an inter prediction image in moving image coding or video coding, wherein a computer executes a first acquisition procedure for acquiring, for each of subblocks included in a coding object block, a region in a reference image that corresponds to the subblock, a second acquisition procedure for referring to block segmentation information of the reference image and acquiring a coding block that is a block of the reference image which includes the region, and a generation procedure for generating, for the coding object block or each of a plurality of coding object blocks, an image obtained by performing an inverse transformation on one or more coding blocks each acquired in the second acquisition procedure as the filter.

### Effects of the Invention

It is possible to reduce a prediction error while curbing the amount of computation.

### BRIEF DESCRIPTION OF DRAWINGS

FIG. 1 is a view showing motion vectors of control points in subblocks.

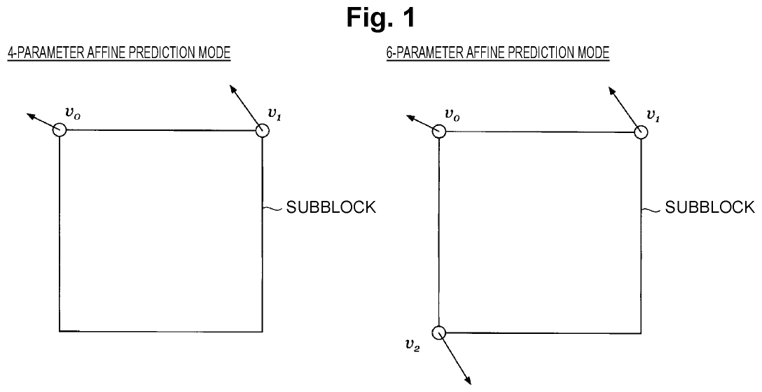

FIG. 2 is a view (Part I) showing an example of object deformation.

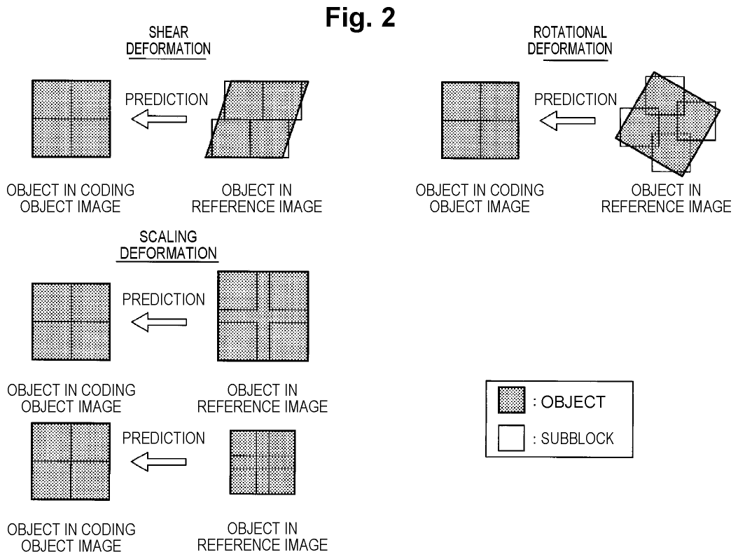

FIG. 3 is a view (Part II) showing an example of object deformation.

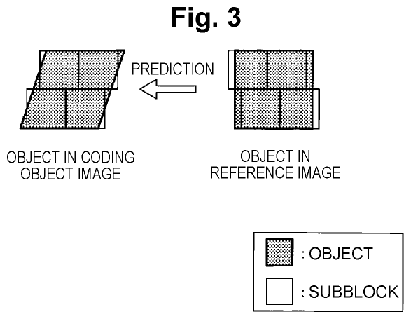

FIG. 4 is a diagram showing an example of an overall configuration of a coding apparatus according to a first embodiment.

FIG. 5 is a diagram showing an example of a functional configuration of a filter generation unit according to the first embodiment.

FIG. 6 is a flowchart showing an example of a filter generation process according to the first embodiment.

FIG. 7 is a diagram showing an example of an overall configuration of a coding apparatus according to a second embodiment.

FIG. 8 is a diagram showing an example of a functional configuration of a filter generation unit according to the second embodiment.

FIG. 9 is a flowchart showing an example of a filter generation process according to the second embodiment.

FIG. 10 is a diagram showing an example of a hardware configuration of a coding apparatus according to one embodiment.

### DESCRIPTION OF EMBODIMENTS

Embodiments of the present invention will be described below. Each embodiment of the present invention will describe a case of creating a prediction image, in which a prediction error due to various types of transformations (e.g., affine transformation, projective transformation, and bilinear transformation) at the time of moving image coding or video coding is reduced, while curbing the amount of computation of the transformations and utilizing the prediction image as a filter. Note that, hereinafter, a prediction error will also be referred to as a “prediction residual error.”

A first embodiment to be described below will describe a case where a filter in question is applied as an in-loop filter. A second embodiment will describe a case where a filter in question is applied as a post-filter, and a combination with merge mode is made. Note that the embodiments below will be described with affine transformation as an example in mind.

### First Embodiment

Hereinafter, the first embodiment will be described.

(Overall Configuration)

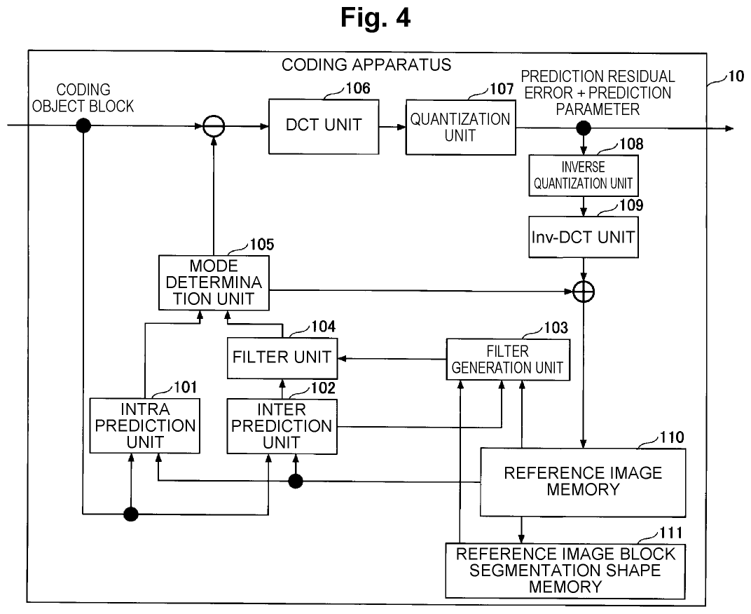

First, an overall configuration of a coding apparatus 10 according to the first embodiment will be described with reference to FIG. 4. FIG. 4 is a diagram showing an example of the overall configuration of the coding apparatus 10 according to the first embodiment.

As shown in FIG. 4, the coding apparatus 10 according to the first embodiment has an intra prediction unit 101, an inter prediction unit 102, a filter generation unit 103, a filter unit 104, a mode determination unit 105, a DCT unit 106, a quantization unit 107, an inverse quantization unit 108, an Inv-DCT unit 109, a reference image memory 110, and a reference image block segmentation shape memory 111.

The intra prediction unit 101 generates a prediction image (an intra prediction image) of a coding object block by known intra prediction. The inter prediction unit 102 generates a prediction image (an inter prediction image) of the coding object block by known inter prediction. The filter generation unit 103 generates a filter for modifying (filtering) the inter prediction image. The filter unit 104 filters the inter prediction image using the filter generated by the filter generation unit 103. Note that the filter unit 104 may calculate, for example, a per-pixel weighted mean of the inter prediction image and the filter as filtering.

The mode determination unit 105 determines which one of intra prediction mode and inter prediction mode is selected. The DCT unit 106 performs a discrete cosine transform (DCT) on a prediction residual error between the coding object block and the inter prediction image or the intra prediction image by a known method, in accordance with a result of the determination by the mode determination unit 105. The quantization unit 107 quantizes the prediction residual error after the discrete cosine transform by a known method. For this reason, the prediction residual error after the discrete cosine transform and the quantization and a prediction parameter used for the intra prediction or the inter prediction are outputted. The prediction residual error and the prediction parameter are a result of coding the coding object block.

The inverse quantization unit 108 inversely quantizes the prediction residual error outputted from the quantization unit 107 by a known method. The Inv-DCT unit 109 performs an inverse discrete cosine transform (Inverse DCT) on the prediction residual error after the inverse quantization by a known method. A decoding image obtained through decoding using the prediction residual error after the inverse discrete cosine transform and the intra prediction image or the inter prediction image (after the filter by the filter unit 104) is stored in the reference image memory 110. A block segmentation shape (e.g., quadtree block segmentation information) when a reference image is coded is stored in the reference image block segmentation shape memory 111.

(Functional Configuration of Filter Generation Unit 103)

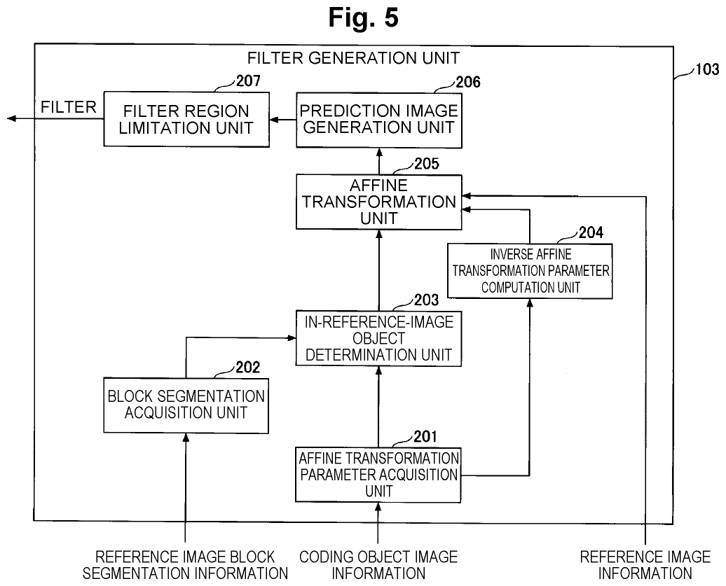

A detailed functional configuration of the filter generation unit 103 according to the first embodiment will be described with reference to FIG. 5. FIG. 5 is a diagram showing an example of the functional configuration of the filter generation unit 103 according to the first embodiment.

As shown in FIG. 5, the filter generation unit 103 according to the first embodiment includes an affine transformation parameter acquisition unit 201, a block segmentation acquisition unit 202, an in-reference-image object determination unit 203, an inverse affine transformation parameter computation unit 204, an affine transformation unit 205, a prediction image generation unit 206, and a filter region limitation unit 207. Here, reference image block segmentation information, coding object image information, and reference image information are inputted to the filter generation unit 103. The reference image block segmentation information is information representing block segmentation of a reference image. The coding object image information is information including pixel information of a coding object block, inter prediction mode information (including merge mode information and an affine parameter), and an index indicating the reference image. The reference image information is pixel information of the reference image.

The affine transformation parameter acquisition unit 201 acquires the affine parameter used for affine transformation. The block segmentation acquisition unit 202 acquires a reference region (a corresponding rectangular region in the reference image) corresponding to a given subblock of the coding object block, refers to the reference image block segmentation information, and acquires a coding block which fully includes the reference region. Note that the acquisition of the coding block fully including the reference region excludes a portion protruding (even if only partially) from an object region of a coding object. It is thus possible to acquire a more accurate region than that by conventional rectangle approximation.

The in-reference-image object determination unit 203 adds a coding block to a block set indicating a region of an object in the reference image if the coding block is acquired by the block segmentation acquisition unit 202. The inverse affine transformation parameter computation unit 204 calculates an inverse affine parameter used for inverse affine transformation. The affine transformation unit 205 uses the inverse affine parameter to perform an inverse affine transformation on the block set created by the in-reference-image object determination unit 203. The prediction image generation unit 206 generates a new prediction image from a result of the inverse affine transformation by the affine transformation unit 205. The filter region limitation unit 207 sets an image limited to a region corresponding to the coding object block of a region of the prediction image generated by the prediction image generation unit 206 as a filter (i.e., a filter through which the region corresponding to the coding object block of the prediction image is passed).

(Filter Generation Process)

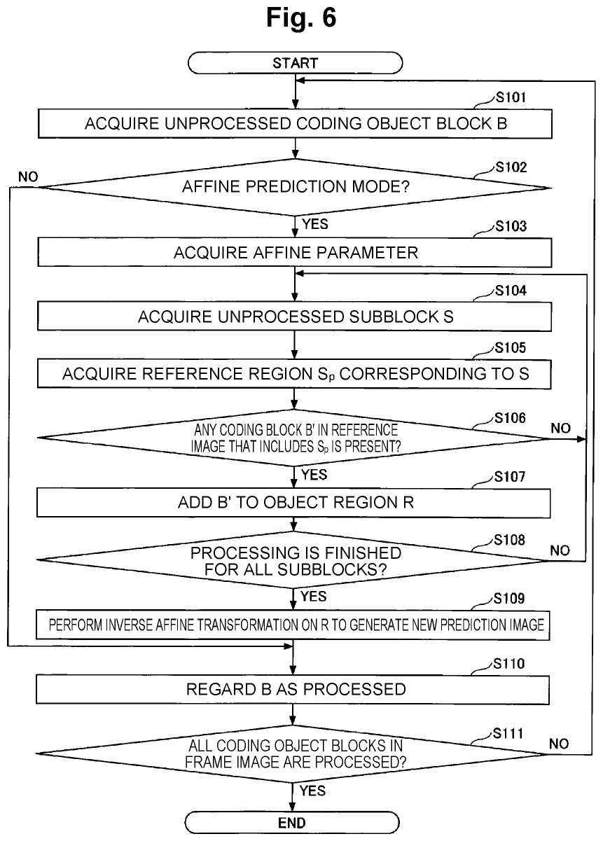

A filter generation process to be executed by the filter generation unit 103 according to the first embodiment will be described with reference to FIG. 6. FIG. 6 is a flowchart showing an example of the filter generation process according to the first embodiment. Note that, hereinafter, a case of generating, at the time of coding respective blocks (coding object blocks) of a given frame image, respective filters for inter prediction images of the coding object blocks will be described.

First, the filter generation unit 103 acquires a coding object block B, for which a prediction image update process (i.e., steps S102 to S110 (to be described later)) has not been performed, (step S101). The filter generation unit 103 then determines, for the coding object block B, whether affine prediction mode is selected, (step S102).

If it is not determined in step S102 above that affine prediction mode is selected, the filter generation unit 103 does not perform processing on the coding object block B and advances to step S110. On the other hand, if it is determined in step S102 above that affine prediction mode is selected, the affine transformation parameter acquisition unit 201 of the filter generation unit 103 acquires an affine parameter, (step S103).

Subsequently to step S103, the filter generation unit 103 acquires, of subblocks S's included in the coding block B, a subblock S, for which a process (i.e., steps S105 to S106 (to be described later)) for identifying a reference region has not been performed, (step S104). The block segmentation acquisition unit 202 of the filter generation unit 103 then calculates a motion vector of the subblock S in accordance with known affine prediction mode processing (i.e., performs motion compensation) to acquire a reference region Sₚ corresponding to the subblock S, (step S105). The block segmentation acquisition unit 202 of the filter generation unit 103 then refers to reference image block segmentation information (an example of a coding parameter) to determine whether any coding block B′ that fully includes the reference region Sₚ is present, (step S106).

If it is not determined in step S106 above that any coding block B′ fully including the reference region Sₚ is present, the filter generation unit 103 regards the subblock S as processed and returns to step S104. On the other hand, if it is determined that any coding block B′ fully including the reference region Sₚ is present, the filter generation unit 103 acquires the coding block B′ by means of the block segmentation acquisition unit 202 and adds the coding block B′ to a block set R which indicates a region of an object in a reference image by means of the in-reference-image object determination unit 203, (step S107). In this case, the filter generation unit 103 regards the subblock S as processed.

Subsequently, the filter generation unit 103 determines whether processing is finished for all the subblocks included in the coding block B (i.e., whether the process for identifying a reference region has been performed for all the subblocks), (step S108).

If it is not determined in step S108 above that processing is finished for all the subblocks included in the coding block B, the filter generation unit 103 returns to step S104. For this reason, steps S104 to S108 (or steps S104 to S106 if NO in step S106) are repeatedly executed for all the subblocks included in the coding block B.

On the other hand, if it is determined in step S108 above that processing is finished for all the subblocks included in the coding block B, the filter generation unit 103 computes an inverse affine parameter by means of the inverse affine transformation parameter computation unit 204, uses the inverse affine parameter to perform an inverse affine transformation on the block set R (i.e., perform an inverse transformation of an affine transformation on the coding object block B) by means of the affine transformation unit 205, and sets the block set R after the inverse affine transformation as a new prediction image by means of the prediction image generation unit 206, (step S109). With limitation to a region corresponding to the coding object block B of a region of the prediction image (i.e., with limitation of an application region of the prediction image) by the filter region limitation unit 207, a filter for the coding object block B is obtained. The limitation of a region to be used as a filter of the prediction image is caused to prevent a coded pixel from being changed and becoming unable to undergo decoding processing if a region after the inverse affine transformation of the block set R includes a position of the coded pixel other than the coding object block B.

Subsequently, the filter generation unit 103 regards the coding object block B acquired in step S101 above as processed, (step S110), and determines whether all the coding object blocks in the frame image are processed (i.e., whether the prediction image update process has been performed for all the coding object blocks), (step S111).

If it is not determined in step S111 above that all the coding object blocks are processed, the filter generation unit 103 returns to step S101. For this reason, steps S101 to S111 (or steps S101 to S102 and steps S110 to S111 if NO in step S102) are repeatedly executed for all the coding blocks included in the frame image.

On the other hand, if it is determined in step S111 above that all the coding object blocks are processed, the filter generation unit 103 ends the filter generation process. In the above-described manner, a filter for each coding object block included in one frame image is generated.

### Second Embodiment

Hereinafter, a second embodiment will be described. Note that the second embodiment will mainly describe differences from the first embodiment and that a description of the same components as the first embodiment will be appropriately omitted.

(Overall Configuration)

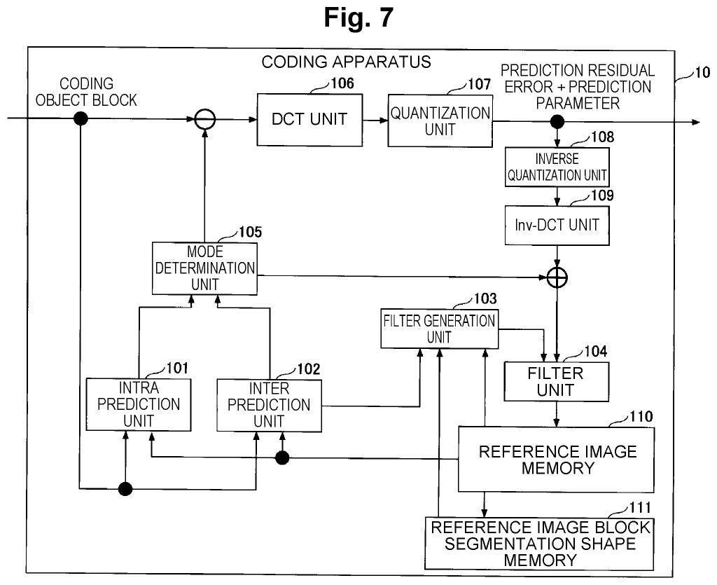

First, an overall configuration of a coding apparatus 10 according to the second embodiment will be described with reference to FIG. 7. FIG. 7 is a diagram showing an example of the overall configuration of the coding apparatus 10 according to the second embodiment.

As shown in FIG. 7, the coding apparatus 10 according to the second embodiment has an intra prediction unit 101, an inter prediction unit 102, a filter generation unit 103, a filter unit 104, a mode determination unit 105, a DCT unit 106, a quantization unit 107, an inverse quantization unit 108, an Inv-DCT unit 109, a reference image memory 110, and a reference image block segmentation shape memory 111.

The second embodiment is different in a position of the filter unit 104. In the second embodiment, the filter unit 104 filters a decoding image (i.e., a decoding image obtained through decoding using an inter prediction image and a prediction residual error after inverse discrete cosine transform by the Inv-DCT unit 109).

(Functional Configuration of Filter Generation Unit 103)

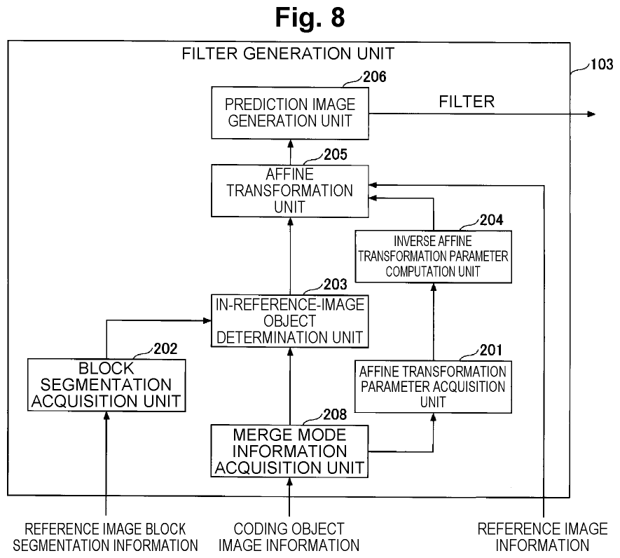

A detailed functional configuration of the filter generation unit 103 according to the second embodiment will be described with reference to FIG. 8. FIG. 8 is a diagram showing an example of the functional configuration of the filter generation unit 103 according to the second embodiment.

As shown in FIG. 8, the filter generation unit 103 according to the second embodiment includes an affine transformation parameter acquisition unit 201, a block segmentation acquisition unit 202, an in-reference-image object determination unit 203, an inverse affine transformation parameter computation unit 204, an affine transformation unit 205, a prediction image generation unit 206, and a merge mode information acquisition unit 208. The second embodiment assumes that coding object image information includes merge mode information. The merge mode information acquisition unit 208 acquires merge mode information from coding object image information.

(Filter Generation Process)

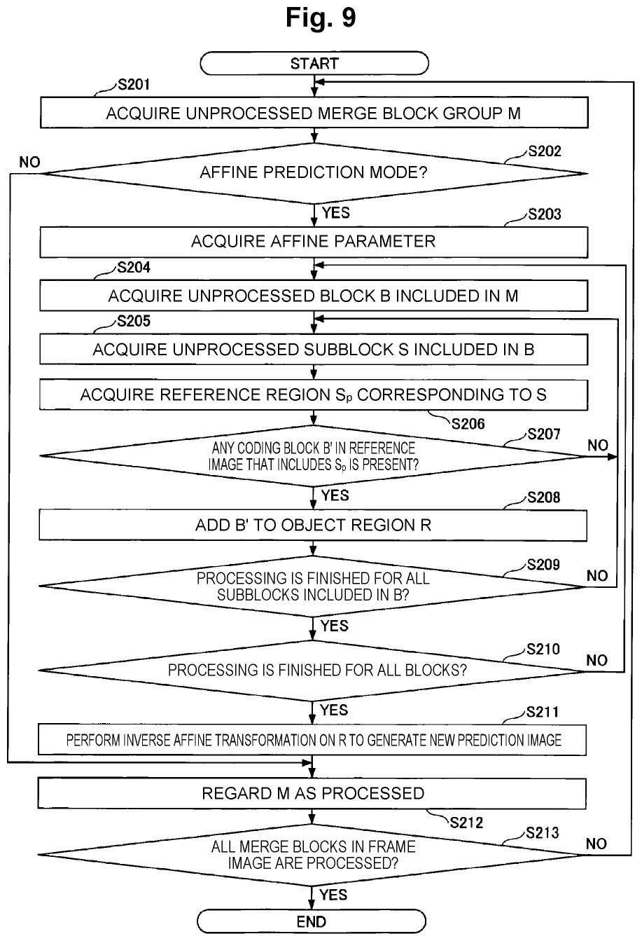

A filter generation process to be executed by the filter generation unit 103 according to the second embodiment will be described with reference to FIG. 9. FIG. 9 is a flowchart showing an example of the filter generation process according to the second embodiment. Note that, hereinafter, a case of generating, at the time of coding respective blocks (coding object blocks) of a given frame image, respective filters for decoding images of the coding object blocks will be described.

First, the filter generation unit 103 uses merge mode information acquired by the merge mode information acquisition unit 208 to acquire an unprocessed merge block group M (i.e., a merge block group M, for which processes in steps S202 to S212 (to be described later) have not been performed) in the frame image, (step S201). The filter generation unit 103 then determines, for the merge block group M, whether affine prediction mode is selected, (step S202).

If it is not determined in step S202 above that affine prediction mode is selected, the filter generation unit 103 does not perform processing for the merge block group M and advances to step S212. On the other hand, if it is determined in step S202 above that affine prediction mode is selected, the affine transformation parameter acquisition unit 201 of the filter generation unit 103 acquires an affine parameter, (step S203).

Subsequently to step S203, the filter generation unit 103 acquires, of coding blocks B included in the merge block group M, a coding block B, for which a prediction image update process (i.e., a process of steps S202 to S211 (to be described later)) has not been performed, (step S204). The filter generation unit 103 then acquires, of subblocks S's included in the coding block B, a subblock S, for which a process (i.e., a process of steps S206 to S207 (to be described later)) for identifying a reference region has not been performed, (step S205). The block segmentation acquisition unit 202 of the filter generation unit 103 then calculates a motion vector of the subblock S in accordance with known affine prediction mode processing (i.e., performs motion compensation) to acquire a reference region Sₚ corresponding to the subblock S, (step S206). The block segmentation acquisition unit 202 of the filter generation unit 103 then refers to reference image block segmentation information (an example of a coding parameter) to determine whether any coding block B′ that fully includes the reference region Sₚ is present, (step S207).

If it is not determined in step S207 above that any coding block B′ fully including the reference region Sₚ is present, the filter generation unit 103 regards the subblock S as processed and returns to step S205. On the other hand, if it is determined that any coding block B′ fully including the reference region Sₚ is present, the filter generation unit 103 acquires the coding block B′ by means of the block segmentation acquisition unit 202 and adds the coding block B′ to a block set R which indicates a region of an object in a reference image by means of the in-reference-image object determination unit 203, (step S208). In this case, the filter generation unit 103 regards the subblock S as processed.

Subsequently, the filter generation unit 103 determines whether processing is finished for all the subblocks included in the coding block B (i.e., whether the process for identifying a reference region has been performed for all the subblocks), (step S209).

If it is not determined in step S209 above that processing is finished for all the subblocks included in the coding block B, the filter generation unit 103 returns to step S205. For this reason, steps S205 to S209 (or steps S205 to S207 if NO in step S207) are repeatedly executed for all the subblocks S's included in the coding block B.

On the other hand, if it is determined in step S209 above that processing is finished for all the subblocks included in the coding block B, the filter generation unit 103 regards the coding block B as processed and determines whether processing is finished for all the coding blocks included in the merge block group M (i.e., whether the prediction image update process has been performed for all the coding object blocks), (step S210).

If it is not determined in step S210 above that processing is finished for all the coding blocks included in the merge block group M, the filter generation unit 103 returns to step S204. For this reason, steps S204 to S210 are repeatedly executed for all the coding blocks B included in the merge block group M.

On the other hand, if it is determined in step S210 above that processing is finished for all the coding blocks included in the merge block group M, the filter generation unit 103 computes an inverse affine parameter by means of the inverse affine transformation parameter computation unit 204, uses the inverse affine parameter to perform an inverse affine transformation on the block set R (i.e., perform an inverse transformation of an affine transformation on the coding object block B) by means of the affine transformation unit 205, and sets the block set R after the inverse affine transformation as a new prediction image by means of the prediction image generation unit 206, (step S211). The prediction image, i.e., a filter for a decoding image is obtained. Since the prediction image is applied not as an in-loop filter but as a post-filter in the second embodiment, it is not necessary to limit an application region of the prediction image to a region corresponding to the merge block group M. However, the effect of preventing image quality degradation in a case where a coding block B′ in the prediction image covers a wide range including not only an object corresponding to the merge block group M but also a background region is expected from limiting the application region of the prediction image to (pixels of) the region corresponding to the merge block group M, as in the first embodiment.

Subsequently, the filter generation unit 103 regards the merge block group M acquired in step S201 above as processed, (step S212), and determines whether all merge block groups in the frame image are processed (i.e., whether processes in steps S202 to S212 have been performed for all the merge block groups M's in the frame image), (step S213).

If it is not determined in step S213 above that all the merge block groups are processed, the filter generation unit 103 returns to step S201. For this reason, steps S201 to S213 (or steps S201 to S202 and steps S212 to S213 if NO in step S202) are repeatedly executed for all the merge block groups included in the frame image.

On the other hand, if it is determined in step S213 above that all the merge block groups are processed, the filter generation unit 103 ends the filter generation process. In the above-described manner, a filter corresponding to each merge block group included in one frame image is generated.

[Hardware Configuration]

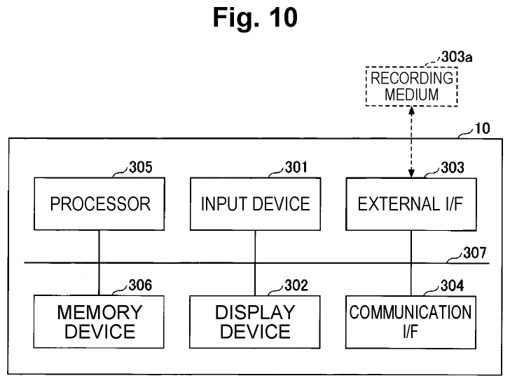

A hardware configuration of the coding apparatus 10 according to each of the above-described embodiments will be described with reference to FIG. 10. FIG. 10 is a diagram showing an example of a hardware configuration of a coding apparatus 10 according to one embodiment.

As shown in FIG. 10, the coding apparatus 10 according to the one embodiment has an input device 301, a display device 302, an external I/F 303, a communication I/F 304, a processor 305, and a memory device 306. The pieces of hardware each are connected so as to be capable of communication via a bus 307.

The input device 301 is, for example, a keyboard, a mouse, a touch panel, or the like. The display device 302 is, for example, a display or the like. Note that the coding apparatus 10 need not have at least one of the input device 301 and the display device 302.

The external I/F 303 is an interface with an external apparatus. As the external apparatus, for example, a recording medium 303a, such as a CD (Compact Disc), a DVD (Digital Versatile Disk), an SD memory card (Secure Digital memory card), or a USB (Universal Serial Bus) memory card, is available.

The communication I/F 304 is an interface for connecting the coding apparatus 10 to a communication network. The processor 305 is, for example, one of various types of arithmetic devices, such as a CPU (Central Processing Unit) or a GPU (Graphics Processing Unit). The memory device 306 is, for example, one of various types of storage devices, such as an HDD (Hard Disk Drive), an SSD (Solid State Drive), a RAM (Random Access Memory), a ROM (Read Only Memory), or a flash memory.

The coding apparatus 10 according to each of the embodiments has the hardware configuration shown in FIG. 10, thereby being capable of implementing the filter generation process and the like described above. Note that the hardware configuration shown in FIG. 10 is an example and that the coding apparatus 10 may have another hardware configuration. For example, the coding apparatus 10 may have a plurality of processors 305 or a plurality of memory devices 306.

[Conclusion]

As described above, the coding apparatuses 10 according to the first and second embodiments create, as a filter for an inter prediction image, a prediction image, in which a prediction residual error (a prediction error) due to various types of transformations (affine transformation is named as an example above) at the time of moving image coding or video coding is reduced, while curbing the amount of computation of the transformations. This allows the coding apparatuses 10 according to the first and second embodiments to reduce a prediction residual error while curbing the amount of computation and improve image quality of a decoding image. Note that, for example, the effects can be expected from the coding apparatuses 10 according to the first and second embodiments, especially in a case where affine prediction is often selected, as in inter-view prediction in a stereo image, a multi-view image, or a LightField image.

Note that although the first and second embodiments have described the coding apparatus 10 having the filter generation unit 103 as an example, the present invention is not limited to this. For example, a filter generation apparatus different from the coding apparatus 10 may have the filter generation unit 103.

The present invention is not limited to the above-described embodiments that are specifically disclosed, and various modifications, changes, combinations with known techniques, and the like can be made without departing from the description of the claims.

### REFERENCE SIGNS LIST

10 Coding apparatus
101 Intra prediction unit
102 Inter prediction unit
103 Filter generation unit
104 Filter unit
105 Mode determination unit
106 DCT unit
107 Quantization unit
108 Inverse quantization unit
109 Inv-DCT unit
110 Reference image memory
111 Reference image block segmentation shape memory
201 affine transformation parameter acquisition unit
202 Block segmentation acquisition unit
203 In-reference-image object determination unit
204 Inverse affine transformation parameter computation unit
205 affine transformation unit
206 Prediction image generation unit
207 Filter region limitation unit
208 Merge mode information acquisition unit

1. A computer implemented method for generating a filter for an inter prediction image in moving image coding or video coding, the method comprising:
acquiring, for each of subblocks included in a coding object block, a region in a reference image that corresponds to a subblock;
referring to block segmentation information of the reference image;
acquiring a coding block, the coding block including a block of the reference image which includes the region; and
generating, for each of a plurality of coding object blocks, an image as the filter by performing an inverse transformation on the acquired coding block.

2. The computer implemented method according to claim 1, wherein
the generating comprises:
generating the image as the filter, through which a region corresponding to a region represented by the coding object block or a region represented by the plurality of decoding object blocks is passed.

3. The computer implemented method according to claim 1, wherein
the inverse transformation includes an inverse transformation of a transformation on the coding object block, and
the transformation includes one of affine transformation, projective transformation, or bilinear transformation.

4. A filter generation device for generating a filter for an inter prediction image in moving image coding or video coding, comprising a processor configured to execute a method comprising:
acquiring, for each of subblocks included in a coding object block, a region in a reference image that corresponds to a subblock;
referring to block segmentation information of the reference image;
acquiring a coding block, the coding block representing a block of the reference image which includes the region; and
generating, for the coding object block, an image as the filter by performing an inverse transformation on the acquired coding block.

5. A computer-readable non-transitory recording medium storing computer-executable program instructions that when executed by a processor cause a computer to execute a method comprising:
acquiring, for each of subblocks included in a coding object block, a region in a reference image that corresponds to a subblock;
referring to block segmentation information of the reference image;
acquiring a coding block, the coding block representing a block of the reference image which includes the region; and
generating, for the coding object block or the acquired coding object block, an image as the filter by performing an inverse transformation on the acquired coding block.

6. The computer implemented method according to claim 1, wherein the filter is associated with the inter prediction image of the coding object block.

7. The computer implemented method according to claim 2, wherein
the inverse transformation includes an inverse transformation of a transformation on the coding object block, and
the transformation includes one of affine transformation, projective transformation, or bilinear transformation.

8. The filter generation device according to claim 4, wherein the generating comprises:
generating the image as the filter, through which a region corresponding to a region represented by the coding object block or a region represented by the plurality of decoding object blocks is passed.

9. The filter generation device according to claim 4, wherein the filter is associated with the inter prediction image of the coding object block.

10. The filter generation device according to claim 4, wherein
the inverse transformation includes an inverse transformation of a transformation on the coding object block, and
the transformation includes one of affine transformation, projective transformation, or bilinear transformation.

11. The filter generation device according to claim 8, wherein
the inverse transformation includes an inverse transformation of a transformation on the coding object block, and
the transformation includes one of affine transformation, projective transformation, or bilinear transformation.

12. The computer-readable non-transitory recording medium according to claim 5, wherein the generating comprises:
generating the image as the filter, through which a region corresponding to a region represented by the coding object block or a region represented by the plurality of decoding object blocks is passed.

13. The computer-readable non-transitory recording medium according to claim 5, wherein the filter is associated with an inter prediction image of the coding object block.

14. The computer-readable non-transitory recording medium according to claim 5, wherein
the inverse transformation includes an inverse transformation of a transformation on the coding object block, and
the transformation includes one of affine transformation, projective transformation, or bilinear transformation.

15. The computer-readable non-transitory recording medium according to claim 12, wherein
the inverse transformation includes an inverse transformation of a transformation on the coding object block, and
the transformation includes one of affine transformation, projective transformation, or bilinear transformation.
